(19) United States
(12) Patent Application Publication
(10) Pub. No.: US 2003/0094082 A1
(43) Pub. Date: May 22, 2003

(54) Device for providing miter saw settings

(76) Inventor: Ofer Meged, Highland Park, IL (US)

Correspondence Address: OFER MEGED, 260 BRIAR LN., HIGHLAND PARK, IL, 60035, US

(21) Appl. No.: 09/742,850

(22) Filed: Dec. 20, 2000

(51) Int. Cl. B26D 1/00; B26D 3/00; B26D 5/08

(52) U.S. Cl. 83/13; 83/581

(57) ABSTRACT

A device for obtaining miter saw settings for cutting material to mitered together wherein the settings may be obtained without measuring the angle of the surface material. The device comprises a frame having a setting scale and first and second pivotally attached arms, wherein the setting scale corresponds to the settings on a miter saw.

### FIELD OF THE INVENTION

The present invention relates to a device for providing miter saw settings, and more specifically, to device having a setting scale and a pair of pivot arms whereby the pivot arms are matched to angled surfaces to be fitted with material joined by mitering, and the arms are rotated against the setting scale of the device to provide the corresponding setting on a miter saw for making mitered cuts in the fitted material.

### BACKGROUND OF THE INVENTION

When shaping two pieces of material to be joined at a selected angle, there is always a significant problem in providing an angle on each piece such that the two angles will join to form the selected angle. Cutting pieces of wood with a miter guide on a table saw to form mating surfaces on separate pieces of wood to make a trim joint is but one example. In cutting trim for a house, for instance, most walls are not joined at perfect 90° angles. Thus, each individual corner must be measured separately and very accurately. Next, each separate angle measured must be converted into a measurement for a cut using a miter saw or a miter box. This is an extremely time-consuming and laborious process, particularly where each angle is different. Accordingly, few workers possess the requisite level of attention to detail to correctly perform this task. Also, the cutting scale on a miter saw is generally semi-circular, with markings from 0 to 45 on the left side of the semicircle, and from 0 to 45 or 60 on the right side of the semicircle. Thus, an angular measurement of greater than 45° does not correlate directly to the markings on a miter box.

Traditionally, materials for mitered joints are cut using a largely trial and error process, with a significant rate of failure and the need to recut material frequently for all but very skilled finish carpenters. One reason for this failure is the difficulty of measuring wall angles ranging from acute (less than 90°) to obtuse (greater than 90°), very few of which are square (exactly 90°), with conventional measuring tools such as a compass or protractor. Other difficulties include calculating the proper angle at which to cut the material, since the appropriate setting on the miter saw is different from the measured wall angle for most angled surfaces, as discussed above. Moreover, if the saw cut is wrongly set for the first cut, the second piece will also be cut wrongly. Thus, it is important to be correct in making measurements and calculating correct saw settings based on such measurements.

While devices for measuring wall angles for mitered cutting exist, these devices suffer from a number of drawbacks. First, measuring the wall angle and dividing by two will not provide the corresponding measurement on the miter saw for oblique angles. In a miter saw, 0 on the saw scale corresponds to an angular measurement of 90°. To cut miter cuts corresponding to acute or right angles, for instance, a 90° angle, the corresponding measurement on the miter saw is the angular measurement divided by 2. For obtuse angles, however, the calculation is different—the proper setting is calculated by taking 180 minus the angular measurement, divided by two. For example, if an outside angle measures 128°, the proper miter saw setting is (180-128)/2, or 26. Although carpenters know that 128 divided by 2 would not be a correct setting, many carpenters do not know the correct formula and thus the conventional practice is to guess at the correct miter saw setting. This practice of estimating understandably leads to frequent errors.

A number of tools exist for measuring an angle between two planar surfaces, and such devices are generally two pivotally joined arms which are joined by a protractor scale indicating the angle between the two arms. Various configurations applying this general principle are known in the art. However, there are instances when the measure of the inner angle between two surfaces is inaccessible to such devices due to their shape. Also, these devices cannot conveniently measure outer angles (generally greater than 180°) because of the limited span of the setting scale used. Thus, traditionally, two separate instruments have been required to measure both inner and outer angles. Lastly, while these instruments provide surface angles, they do not provide or calculate miter saw settings.

Therefore, there is a need for a single device that easily and rapidly provides miter saw settings for both inner and outer angular surfaces, that is easy to manufacture and has relatively few parts.

### SUMMARY OF THE INVENTION

Accordingly, it is an object of the invention to provide a device for obtaining miter saw settings for making angled cuts that correspond to angled surfaces, without the need to measure surface angles directly.

A further object of the invention is to provide a single device that can be used to provide miter saw settings that correspond to both inner and outer surface angles.

Yet another object is to provide a device for making rapid determinations of miter saw settings for material to be cut at an angle.

Another object of the invention is to provide a device for obtaining miter saw settings for fitting material to angled surfaces whereby no calculations are needed.

In accordance with the present invention, all of these objects, as well as others not herein specifically identified, are achieved generally by the present miter saw setting device which includes two pivotally joined segments attached to a scale having saw settings inscribed thereon.

More specifically, the invention pertains to device for obtaining miter saw settings for cutting material to joined by mitering, wherein the material must correspond to an angled surface, such as a wall, and wherein the settings may be obtained without measuring the angle of the surface material. The device comprises two pivotally joined arms, a setting scale and lip, wherein the arms are placed in an orientation opposite the surface material, then rotated to rest against a measurement on the scale that provides the miter saw setting corresponding to the surface material.

### BRIEF DESCRIPTION OF THE DRAWINGS

FIG. 1 is a top perspective view of one embodiment of the invention.

FIG. 2 is a perspective view of the device of the invention shown in position to provide settings for a miter cut to an inside angular surface.

FIG. 3 is a perspective view of the device of the invention shown in position to provide settings for a miter cut corresponding to an inside angular surface.

FIG. 4 illustrates placement of the pivotal segments along the setting scale to provide a cutting measurement.

### DETAILED DESCRIPTION OF THE INVENTION

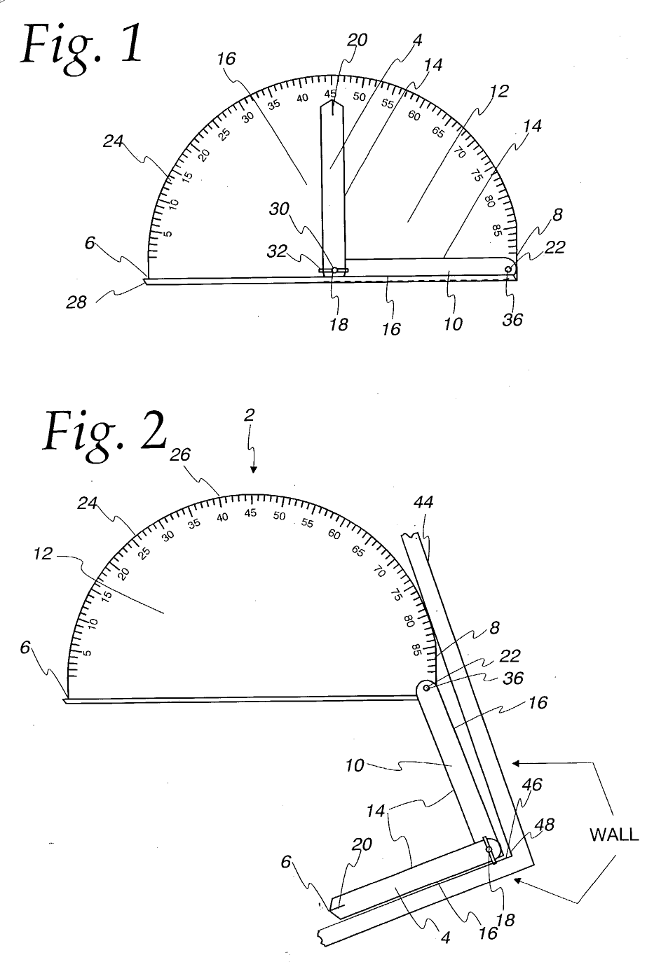

Referring to FIG. 1, the device of the invention is generally designated as item 2. The device 2 includes a first arm 4 and a second arm 10 and a frame 12. The frame has a pointed end 6 and a blunt end 8. Each arm 4 and 10 has an inner edge 14 and an outer edge 16. The first and second arms, 4 and 10 respectively, are pivotally joined at a first pivot joint, 18. The ends of the segments 4 and 10 are rounded near pivot joint 18 so that the edges 14 and 16 of the arms 4 and 10 can be placed against the surfaces being measured regardless of the angle formed between the surfaces. The first arm 4 is inscribed with a pointer 20. A second pivot joint 22, is formed between the second arm 10 and the frame 12, near the blunt end 8. The frame 12 is equipped with a setting scale 24, which is inscribed with a series of markings, 26. The markings are calibrated to indicate cutting measurements corresponding to the setting scale on a miter saw. The frame 12 is further attached to a lip 28. The frame may be made of any suitable stiff material, such as but not limited to metal or plastic. In a preferred embodiment, the lip 28 is constructed of the same material as the frame 12.

As shown in FIG. 1, the structure near the pivotal joint 18 is described here in more detail. The two arms 4 and 10 are joined at the pivotal joint 18 by a screw 30 that engages an adjustable nut 32, so that the angle between the arms 4 and 10 may be secured. Of course, many alternative ways to pivotally and adjustably fasten the arms 4 and 10 may be utilized without departing from the teachings of the present invention. The second pivot joint 22 need not be adjustable, and the second arm 10 and the scale 12 may be permanently pivotally attached with, for instance, a rivet 36. Again, many alternative ways to pivotally fasten the second arm 10 and the scale 12 may be utilized without departing from the teachings of the present invention.

The lip 28 is attached in a fashion perpendicular to the plane of the frame 12, and forms a backstop on which to place the outer edge 16 of the second arm 10 during reading of the markings 26 on the setting scale 24. The correct measurement on the setting scale 24 is indicated by the pointer 20, when the outer edge 16 of the second arm 10 is positioned adjacent to and at least partly touching the lip 28.

Referring now to FIG. 2, the invention may be utilized to provide miter saw settings that match inside angled surface material, which is generally angled at 90° or less. The surface material may be any angled material for which matching angled material is needed. For example and not by way of limitation, the surface material may be a wall corner, and the matching material to be cut may be trim for that wall. The frame 12 is configured with a blunt end 8 to permit inner angle fittings, as illustrated in FIG. 2. To use the device of the invention to fit material to an inner angled surface such as, for instance, a wall 44, the outer sides 16 of arms 4 and 10 are placed inside the wall angle 46 so that pivot joint 18 as adjacent to the inside angle point 48 of the inside surface 44 to be fitted. Once arms 4 and 10 are adjacent to the inside surface 44, adjustable nut 32 is tightened such that the angular orientation of the arms is secured. Next, the arms are rotated about the second pivot joint 22 until the outer edge 16 of second arm 10 is resting on the lip 28, and the pointer 20 is located on the setting scale 24. To determine the appropriate measure on the miter saw, the marking 26 that corresponds to the position of the pointer 20 is read, as shown in detail in FIG. 4. This marking provides the miter saw setting that is appropriate for the measured angle.

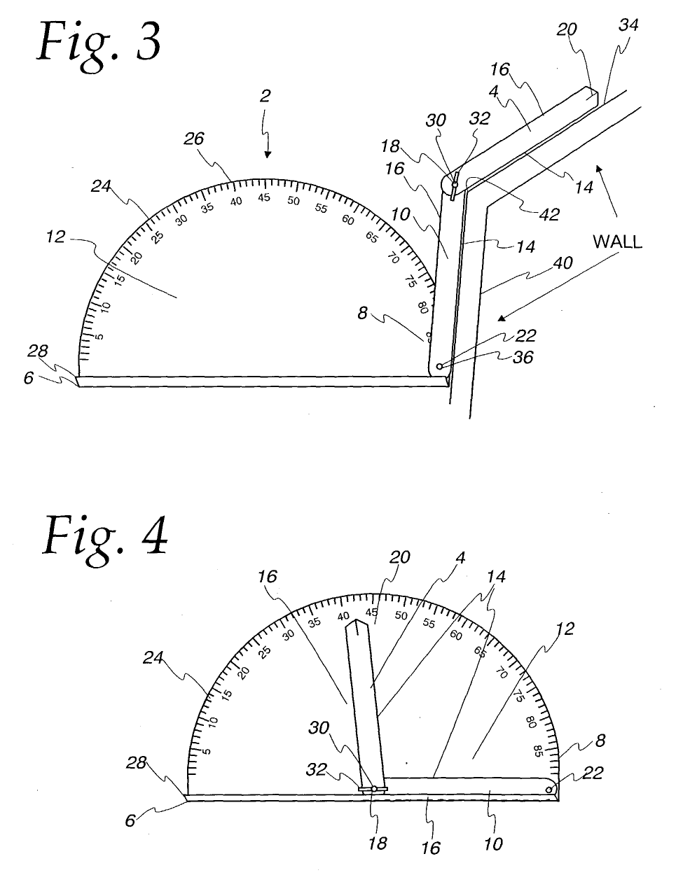

Referring now to FIG. 3, the invention may also be utilized to provide saw settings that match an oblique surface angle, such as an outer corner in a wall, as illustrated in FIG. 3. To use the device of the invention to obtain miter settings corresponding to an outside angular surface 34, the inner sides 14 of arms 4 and 10 are placed around the angle 40 of the surface so that pivot joint 18 as adjacent to the point 42 of the angle in the outside surface 34 to be measured. Once arms 4 and 10 are adjacent to the angle 40, adjustable nut 32 is tightened such that the angular orientation of the arms is secured. Next, the arms are rotated about the second pivot joint 22 until the outer edge 16 of second arm 10 is resting on the lip 28, and the pointer 20 is located on the setting scale 24. To determine the appropriate setting on the miter saw, the marking 26 that corresponds to the position of the pointer 20 is read, as shown in greater detail in FIG. 4. This marking corresponds to the measurement of the miter saw.

Accordingly, the present invention provides a single new and convenient device that can be utilized to obtain miter saw settings for cutting materials to correspond to both inner and outer corners of any angled surface. Those skilled in the art will appreciate that no direct measurement of the wall angle or calculations are necessary to obtain the miter saw setting; this and the speed at which the settings are obtained are primary advantages of the invention.

While particular embodiments of the present invention have been shown and described, it will be appreciated by those skilled in the art that changes and modifications may be made thereto without departing from the invention in its broader aspects and as set forth in the following claims.

What is claimed is:

1. A device for obtaining miter saw settings for cutting material to joined by mitering, the device comprising:
a frame having a lip;
first and second arms; and
a setting scale,
wherein the first and second arms are pivotally attached to each other at a first pivot joint and the first arm further comprises a pointer opposite first the pivot joint and wherein the second arm is pivotally attached to the frame at a second pivot joint, and wherein the setting scale further comprises markings corresponding to the settings on a miter saw.

2. The device of claim 1 wherein the setting scale comprises markings from 0 to 80.

3. The device of claim 1 wherein the first and second arms are pivotally attached around a pivot joint with an adjustable fastening means wherein the fastening means can be reversibly adjusted to firmly secure said first and second arms together such that there is no pivoting of the arms about each other.

4. The device of claim 3 wherein the adjustable fastening means is a screw and a wing nut.

5. The device of claim 1 wherein the pointer is of sufficient length to contact the setting scale.

6. The device of claim 1, wherein the device is adapted to provide miter saw settings for cuts in material, the settings ranging from 0 to the maximum setting on a miter saw.

7. The device of claim 6, wherein the maximum setting is 60.

8. A device for obtaining miter saw settings for cutting material to joined by mitering that corresponds to an angled surface material, wherein the settings may be obtained without measuring the angle of the surface material.

9. The device of claim 8 wherein the miter saw setting is obtained from the surface material without calculation.

10. A method for obtaining miter saw settings for material to be joined by mitering that matches an angled surface comprising the steps of:
fitting first and second pivotally attached arms to an angled surface;
affixing the pivotally attached arms in place relative to each other;
rotating the pivotally attached arms onto a setting scale having miter saw setting markings inscribed thereon; and
reading the miter saw setting from the scale.
